(19) United States
(12) Patent Application Publication
(10) Pub. No.: US 2015/0062599 A1
(43) Pub. Date: Mar. 5, 2015

(54) METHOD AND APPARATUS FOR CALCULATING INK SAVING AMOUNT

(71) Applicant: PEKING UNIVERSITY FOUNDER GROUP CO., LTD., Beijing (CN)

(72) Inventors: Jia LI, Beijing (CN); Xingbang DING, Beijing (CN)

(73) Assignee: PEKING UNIVERSITY FOUNDER GROUP CO., LTD., Beijing (CN)

(21) Appl. No.: 14/093,786

(22) Filed: Dec. 2, 2013

(30) Foreign Application Priority Data
Aug. 30, 2013 (CN) 201310389336.7

(51) Int. Cl. G06K 15/00; G06K 15/02

(52) U.S. Cl. CPC G06K 15/407; G06K 15/1878
USPC 358/1.9

(57) ABSTRACT

The present invention provides a method and an apparatus for calculating ink saving amount. The method comprises: generating, using an ink-saving solution, first cyan, magenta, yellow and black bitmap files that correspond to a printing layout; generating, using a non-ink-saving solution, second cyan, magenta, yellow, and black bitmap files that correspond to the printing layout; calculating dot percentages of all the bitmap files; calculating percentages of saving amount of cyan, magenta, yellow, and black inks according to the dot percentages of the first cyan, magenta, yellow, and black bitmap files, and the second cyan, magenta, yellow, and black bitmap files.

### BACKGROUND OF THE INVENTION

1. Field of the Invention

The present invention relates to the field of printing technologies, and in particular, to a method and apparatus for calculating ink saving amount, and further to a non-transitory storage medium storing a computer-executable program to implement the method for calculating ink saving amount.

2. Description of the Prior Art

At present, during a production process in the printing field, a large amount of various colors of inks are consumed, which accounts for a large proportion in the production costs. Therefore, an ink saving technology reduces the production costs to some extent and has become a desired technology in the printing field.

Printing inks may be classified into a cyan (C) ink, a magenta (M) ink, a yellow (Y) ink, a black (K) ink, and various spot color inks. Cyan, magenta, yellow, and black inks are widely used in the printing, whereas the spot color inks are rarely used. Since the black ink is relatively cheaper, the essence of the ink saving technology is to re-allocate, using specific formulas, amount of the cyan, yellow, magenta, and black inks during the printing, and replace the expensive cyan, yellow, and magenta inks with a certain amount of cheap black ink on the premise of not affecting the color effect. In this way, the ink cost is reduced.

However, in current ink-saving solutions, there is no available method for calculating ink saving amount after employing an ink-saving solution. Therefore, users may not accurately acquire ink saving amount in the practical production, which cannot aid to the subsequent printing arrangement and ink allocation.

### SUMMARY OF THE INVENTION

Embodiments of the present invention provide a method and an apparatus for calculating ink saving amount, to solve the problem in the prior art that users cannot accurately acquire actual ink saving amount during printing, which cannot aid to subsequent production arrangement and ink allocation.

An embodiment of the present invention provides a method for calculating ink saving amount, comprising:

generating, using an ink-saving solution, a first cyan bitmap file, a first magenta bitmap file, a first yellow bitmap file, and a first black bitmap file that correspond to a printing layout;

generating, using a non-ink-saving solution, a second cyan bitmap file, a second magenta bitmap file, a second yellow bitmap file, and a second black bitmap file that correspond to the printing layout;

calculating dot percentages of the first cyan bitmap file, the first magenta bitmap file, the first yellow bitmap file, the first black bitmap file, the second cyan bitmap file, the second magenta bitmap file, the second yellow bitmap file, and the second black bitmap file; and

calculating a percentage of cyan ink saving amount according to the dot percentages of the first cyan bitmap file and the second cyan bitmap file, calculating a percentage of magenta ink saving amount according to the dot percentages of the first magenta bitmap file and the second magenta bitmap file, calculating a percentage of yellow ink saving amount according to the dot percentages of the first yellow bitmap file and the second yellow bitmap file, and calculating a percentage of black ink saving amount according to the dot percentages of the first black bitmap file and the second black bitmap file.

An embodiment of the present invention provides an apparatus for calculating ink saving amount, comprising:

a first generating module, configured to generate, using an ink-saving solution, a first cyan bitmap file, a first magenta bitmap file, a first yellow bitmap file, and a first black bitmap file that correspond to a printing layout;

a second generating module, configured to generate, using an non-ink-saving solution, a second cyan bitmap file, a second magenta bitmap file, a second yellow bitmap file, and a second black bitmap file that correspond to a printing layout;

a statistical module, configured to calculate dot percentages of the first cyan bitmap file, the first magenta bitmap file, the first yellow bitmap file, the first black bitmap file, the second cyan bitmap file, the second magenta bitmap file, the second yellow bitmap file, and the second black bitmap file; and

a calculating module, configured to calculate a percentage of cyan ink saving amount according to the dot percentages of the first cyan bitmap file and the second cyan bitmap file; calculate a percentage of magenta ink saving amount according to the dot percentages of the first magenta bitmap file and the second magenta bitmap file; calculate a percentage of yellow ink saving amount according to the dot percentages of the first yellow bitmap file and the second yellow bitmap file; and calculate a percentage of black ink saving amount according to the dot percentages of the first black bitmap file and the second black bitmap file.

The method and apparatus for calculating ink saving amount provided by an embodiment of the present invention may aid to subsequent reasonable production arrangement and ink allocation by calculating the dot percentages of the first bitmap files of the four colors by using an ink-saving solution and the dot percentages of the second bitmap files of the four colors by using a non-ink-saving solution, and calculating the percentages of ink saving amount of four colors based on the above calculation results.

In addition, the present invention further provides a non-transitory storage medium, with a computer executable program stored thereon, wherein the program is executed to implement the method for calculating ink saving amount

### BRIEF DESCRIPTION OF THE DRAWINGS

FIG. 1 is a schematic flowchart diagram of a method for calculating ink saving amount according to an embodiment of the present invention; and

FIG. 2 is a schematic structural diagram of an apparatus for calculating ink saving amount according to an embodiment of the present invention.

### DETAILED DESCRIPTION OF THE PREFERRED EMBODIMENTS

The technical solutions according to the present invention are further described with reference to specific embodiments and accompanying drawings.

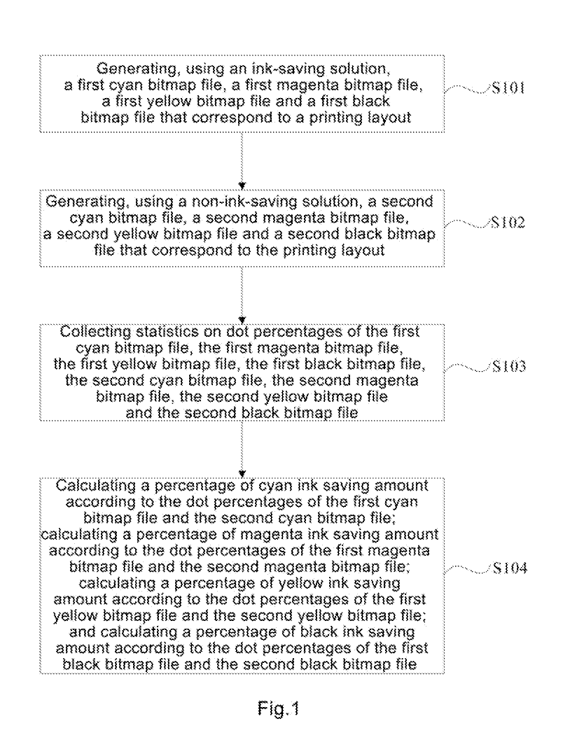

FIG. 1 is a schematic flowchart diagram of a method for calculating ink saving amount according to an embodiment of the present invention. As illustrated in FIG. 1, the method may comprise:

S101. generating, using an ink-saving solution, a first cyan bitmap file, a first magenta bitmap file, a first yellow bitmap file, and a first black bitmap file that correspond to a printing layout.

S102. generating, using a non-ink-saving solution, a second cyan bitmap file, a second magenta bitmap file, a second yellow bitmap file, and a second black bitmap file that correspond to the printing layout.

Specifically, among the parameters of the second bitmap files of the four colors of inks, parameters (for example, resolution and mesh and so on) other than the parameters relating to the ink-saving solution, may be set as identical to those in the first bitmap files of the four colors of inks.

S103. calculating dot percentages of the first cyan bitmap file, the first magenta bitmap file, the first yellow bitmap file, the first black bitmap file, the second cyan bitmap file, the second magenta bitmap file, the second yellow bitmap file, and the second black bitmap file.

Specifically, the dot percentage of each of the bitmap files is calculated using the following formula:

A=B/(C*D*255)*100%;

where A represents a dot percentage of a bitmap file to be calculated;

B represents the number of dots in the bitmap file;

C represents a pixel height value of the bitmap file; and

D represents a pixel width value of the bitmap file.

For example, the dot percentage of the first cyan bitmap file=the number of dots in the first cyan bitmap file/(the pixel height value of the first cyan bitmap file * the pixel width value of the first cyan bitmap file*255)*100%. In this step, totally eight dot percentages corresponding to eight bitmap files are acquired by calculation.

S104. calculating a percentage of cyan ink saving amount according to the dot percentages of the first cyan bitmap file and the second cyan bitmap file; calculating a percentage of magenta ink saving amount according to the dot percentages of the first magenta bitmap file and the second magenta bitmap file; calculating a percentage of yellow ink saving amount according to the dot percentages of the first yellow bitmap file and the second yellow bitmap file; and calculating a percentage of black ink saving amount according to the dot percentages of the first black bitmap file and the second black bitmap file.

Specifically, the percentage of ink saving amount with respect to each of four colors of inks may be calculated by using the following formula:

E=(F−G)/G*100%;

wherein E represents a percentage of saving amount of an ink to be calculated;

F represents a dot percentage of a first bitmap file corresponding to the ink to be calculated; and

G represents a dot percentage of a second bitmap file corresponding to the ink to be calculated.

For example, the percentage of cyan ink saving amount=(the dot percentage of the first cyan bitmap file−the dot percentage of the second cyan bitmap file)/the dot percentage of the second cyan bitmap file*100%. In this step, totally four percentages of ink saving amount corresponding to four colors of inks are acquired by calculation.

In the ink saving solution, a certain amount of cheap black ink is used to replace the expensive cyan, yellow, and magenta inks on the premise of not affecting the color effect. Therefore, the percentages of ink saving amount of cyan, magenta, and yellow inks acquired in this step are negative values, representing the percentages of the saved amount of the cyan, magenta, and yellow inks by using the ink saving solution; and the percentage of black ink saving amount is a positive value, representing that the percentage of the amount of the black ink which is additionally consumed by using the ink saving solution.

For ease of user's query, the eight dot percentages acquired in step S103 and the four percentages of ink saving amount acquired in step S104 may be stored; and in addition, a query interface is provided for the user to query.

It should be noted herein that users may generate a first bitmap file for each of four colors of inks by using other ink-saving solutions, and hence acquire, by calculation, four percentages of ink saving amount corresponding to four colors of inks under these ink-saving solutions. By comparison of the four percentages of ink saving amount under each of the ink-saving solutions, an ink-saving solution with the minimum ink cost is acquired.

It should be noted herein that the first bitmap files of the four colors of inks may be bitmap files of the four colors of inks in the practical printing layout after adopting an ink-saving solution. Since the second bitmap files of the four colors of inks are merely used for calculations of dot percentages and percentages of ink saving amount, these bitmap files may not necessarily be printed. Therefore, the second bitmap files of the four colors of inks may be deleted after the calculation of the percentages of ink saving amount.

The method for calculating ink saving amount provided by an embodiment of the present invention may aid to subsequent reasonable production arrangement and ink allocation by calculating the dot percentages of the first bitmap files of the four colors by using an ink-saving solution and the dot percentages of the second bitmap files of the four colors by using a non-ink-saving solution, and calculating the percentages of ink saving amount of four colors based on the above calculation results.

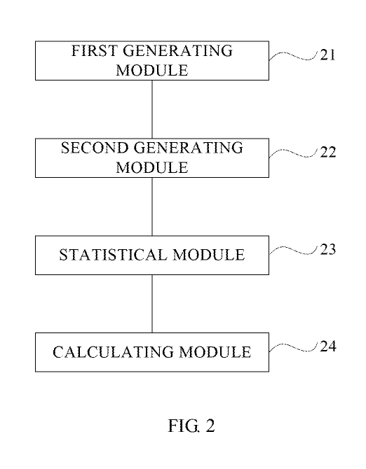

FIG. 2 is a schematic structural diagram of an apparatus for calculating ink saving amount according to an embodiment of the present invention. As illustrated in FIG. 2, the apparatus for calculating ink saving amount is an object to implement the method for calculating ink saving amount. The apparatus may comprise: a first generating module 21, a second generating module 22, a statistical module 23, and a calculating module 24.

The first generating module 21 is configured to generate, using an ink-saving solution, a first cyan bitmap file, a first magenta bitmap file, a first yellow bitmap file, and a first black bitmap file that correspond to a printing layout.

The second generating module 22 is configured to generate, using an non-ink-saving solution, a second cyan bitmap file, a second magenta bitmap file, a second yellow bitmap file, and a second black bitmap file that correspond to a printing layout.

The statistical module 23 is configured to calculating dot percentages of the first cyan bitmap file, the first magenta bitmap file, the first yellow bitmap file, the first black bitmap file, the second cyan bitmap file, the second magenta bitmap file, the second yellow bitmap file, and the second black bitmap file.

The calculating module 24 is configured to: calculate a percentage of cyan ink saving amount according to the dot percentages of the first cyan bitmap file and the second cyan bitmap file; calculate a percentage of magenta ink saving amount according to the dot percentages of the first magenta bitmap file and the second magenta bitmap file; calculate a percentage of yellow ink saving amount according to the dot percentages of the first yellow bitmap file and the second yellow bitmap file; and calculate a percentage of black ink saving amount according to the dot percentages of the first black bitmap file and the second black bitmap file.

Furthermore, the statistical module 23 may calculate the dot percentage of each of the bitmap files by using the following formula:

A=B/(C*D*255)*100%;

wherein A represents a dot percentage of a bitmap file to be calculated; B represents the number of dots in the bitmap file; C represents a pixel height value of the bitmap file; and D represents a pixel width value of the bitmap file.

Furthermore, the calculating module 24 may calculate the percentage of ink saving amount with respect to each of four colors of inks by using the following formula:

E=(F−G)/G*100%;

wherein E represents a percentage of saving amount of an ink to be calculated; F represents a dot percentage of a first bitmap file corresponding to the ink to be calculated; and G represents a dot percentage of a second bitmap file corresponding to the ink to be calculated.

Specifically, with respect to the details about implementation of functions of various modules, reference may be made to related description in the embodiment illustrated in FIG. 1, which are thus not described in details herein any further.

The apparatus for calculating ink saving amount provided by an embodiment of the present invention may aid to subsequent reasonable production arrangement and ink allocation by calculating the dot percentages of the first bitmap files of the four colors by using an ink-saving solution and the dot percentages of the second bitmap files of the four colors by using a non-ink-saving solution, and calculating the percentages of ink saving amount of four colors based on the above calculation results.

It should be finally noted that the above-described embodiments are merely for illustration of the present invention, but are not intended to limit the present invention. Although the present invention is described in detail with reference to these embodiments, a person skilled in the art may also make various modifications to the technical solutions disclosed in the embodiments, or make equivalent replacements to a part of or all technical features contained therein. Such modifications or replacement, which is made without departing from the principles of the present invention, shall fall within the scope of the present invention.

What is claimed is:

1. A method for calculating ink saving amount, comprising:
generating, using an ink-saving solution, a first cyan bitmap file, a first magenta bitmap file, a first yellow bitmap file, and a first black bitmap file that correspond to a printing layout;
generating, using a non-ink-saving solution, a second cyan bitmap file, a second magenta bitmap file, a second yellow bitmap file, and a second black bitmap file that correspond to the printing layout;
calculating dot percentages of the first cyan bitmap file, the first magenta bitmap file, the first yellow bitmap file, the first black bitmap file, the second cyan bitmap file, the second magenta bitmap file, the second yellow bitmap file, and the second black bitmap file; and
calculating a percentage of cyan ink saving amount according to the dot percentages of the first cyan bitmap file and the second cyan bitmap file, calculating a percentage of magenta ink saving amount according to the dot percentages of the first magenta bitmap file and the second magenta bitmap file, calculating a percentage of yellow ink saving amount according to the dot percentages of the first yellow bitmap file and the second yellow bitmap file, and calculating a percentage of black ink saving amount according to the dot percentages of the first black bitmap file and the second black bitmap file.

2. The method according to claim 1, wherein the dot percentage of each of the bitmap files is calculated by using the following formula:
A=B/(C*D*255)*100%;
wherein, A represents a dot percentage of a bitmap file to be calculated;
B represents the number of dots in the bitmap file to be calculated;
C represents a pixel height value of the bitmap file to be calculated; and
D represents a pixel width value of the bitmap file to be calculated.

3. The method according to claim 1, wherein the percentage of ink saving amount with respect to each of four colors of inks is calculated by using the following formula:
E=(F−G)/G*100%;
wherein, E represents a percentage of saving amount of an ink to be calculated;
F represents a dot percentage of a first bitmap file corresponding to the ink to be calculated; and
G represents a dot percentage of a second bitmap file corresponding to the ink to be calculated.

4. The method according to claim 2, wherein the percentage of ink saving amount with respect to each of four colors of inks is calculated by using the following formula:
E=(F−G)/G*100%;
wherein, E represents a percentage of saving amount of an ink to be calculated;
F represents a dot percentage of a first bitmap file corresponding to the ink to be calculated; and
G represents a dot percentage of a second bitmap file corresponding to the ink to be calculated.

5. An apparatus for calculating ink saving amount, comprising:
a first generating module, configured to generate, using an ink-saving solution, a first cyan bitmap file, a first magenta bitmap file, a first yellow bitmap file, and a first black bitmap file that correspond to a printing layout;
a second generating module, configured to generate, using an non-ink-saving solution, a second cyan bitmap file, a second magenta bitmap file, a second yellow bitmap file, and a second black bitmap file that correspond to a printing layout;
a statistical module, configured to calculate dot percentages of the first cyan bitmap file, the first magenta bitmap file, the first yellow bitmap file, the first black bitmap file, the second cyan bitmap file, the second magenta bitmap file, the second yellow bitmap file, and the second black bitmap file; and
a calculating module, configured to calculate a percentage of cyan ink saving amount according to the dot percentages of the first cyan bitmap file and the second cyan bitmap file; calculate a percentage of magenta ink saving amount according to the dot percentages of the first magenta bitmap file and the second magenta bitmap file; calculate a percentage of yellow ink saving amount according to the dot percentages of the first yellow bitmap file and the second yellow bitmap file; and calculate a percentage of black ink saving amount according to the dot percentages of the first black bitmap file and the second black bitmap file.

6. The apparatus according to claim 5, wherein the statistical module calculates dot percentages of the bitmap files by using the following formula: A=B/(C*D*255)*100%;
wherein. A represents a dot percentage of a bitmap file to be calculated;
B represents the number of dots in the bitmap file to be calculated;
C represents a pixel height value of the bitmap file to be calculated; and
D represents a pixel width value of the bitmap file to be calculated.

7. The apparatus according to claim 5, wherein the percentage of ink saving amount with respect to each of four colors of inks is calculated by using the following formula:
E=(F−G)/G*100%;
wherein, E represents a percentage of saving amount of an ink to be calculated;
F represents a dot percentage of a first bitmap file corresponding to the ink to be calculated; and
G represents a dot percentage of a second bitmap file corresponding to the ink to be calculated.

8. The apparatus according to claim 6, wherein the percentage of ink saving amount with respect to each of four colors of inks is calculated by using the following formula:
E=(F−G)/G*100%;
wherein, E represents a percentage of saving amount of an ink to be calculated;
F represents a dot percentage of a first bitmap file corresponding to the ink to be calculated; and
G represents a dot percentage of a second bitmap file corresponding to the ink to be calculated.

9. A non-transitory storage medium, with a computer executable program stored thereon, wherein the program is executed to implement the method for calculating ink saving amount according to claim 1.
